(19) United States
(12) Patent Application Publication
(10) Pub. No.: US 2021/0373651 A1
(43) Pub. Date: Dec. 2, 2021

(54) SYSTEM AND METHOD TO MANUALLY CONTROL BUNDLE OUTFEED APPARATUSES

(71) Applicant: BID GROUP TECHNOLOGIES LTD., Prince George (CA)

(72) Inventor: Francois Gravel, Saguenay (CA)

(21) Appl. No.: 17/333,876

(22) Filed: May 28, 2021

Related U.S. Application Data
(60) Provisional application No. 63/030,946, filed on May 28, 2020.

(51) Int. Cl. G06F 3/01; G06F 3/0481; H04N 7/18; H04N 5/272; G06F 3/0338; H04N 5/232

(52) U.S. Cl. CPC G06F 3/011; G06F 3/0481; H04N 5/23203; H04N 5/272; G06F 3/0338; H04N 7/18

(57) ABSTRACT

A system and method for remotely controlling a plurality of apparatuses comprising a user interface configured to select a group of apparatuses from the plurality of apparatuses, execute actions to control an apparatus and a controller in communication with the user interface, the controller being configured to dynamically and operatively connect the user interface to one of the apparatuses of a group of apparatuses, the connection allowing the user interface to operatively control the apparatus.

### CROSS-REFERENCE TO RELATED APPLICATIONS

The present patent application claims the benefits of priority of U.S. Patent Application No. 63/030,946, entitled “BUNDLE OUTFEED MANAGEMENT METHOD AND APPARATUSES”, and filed at the United States Patent Office on May 28, 2020, the content of which is incorporated herein by reference.

### FIELD OF THE INVENTION

The present invention generally relates to systems and methods for remotely controlling apparatuses. In particular, the present invention relates to systems and methods for remotely controlling apparatuses using dynamic association of controls to one or more apparatuses.

### BACKGROUND OF THE INVENTION

The processing of lumber in the wood processing industry is typically performed in mills comprising multiple large production lines. The production lines are typically vast with multiple machines and apparatus operating complex processing tasks on lumber passing therethrough.

While many lumber production lines are automated, manual operations are sometimes required, such as when a lumber remains is jammed or is an operation was not performed correctly. In such cases, some of the systems and/or apparatus of the production lines are controlled by an operator using one or more consoles comprising numerous switches, dials, and other controls with similar or related production lines commonly assembled into a sector (referred to as an “outfeed sector”) being controlled by a console. Preferably, multiple outfeed sectors are controlled by a single operator having a global view of all the processes to better predict or react to the specific requirements of the production lines.

Understandably, the control of multiple outfeed sectors, and therefore numerous machines or apparatus, results in consoles having a substantially high number of controls. This vast array of controls is suitable for initiating the automatic operation of the production lines but may prove challenging when a manual intervention is required as the high number of controls and possible directions can prove confusing and difficult to operate while reacting to a situation. Their complexity further requires that the operator obtains highly specific, technical and expensive training leaving production mills vulnerable in the event of staffing absence or departure.

Referring now to FIG. 1, a prior art control board 1 for operating the apparatus is illustrated. The prior art controller 1 comprises a plurality of controls 3, with different controls 3 being permanently assigned to the apparatus 30. It may be appreciated that the large number of controls 30 may prove challenging for an operator. Furthermore, it may be challenging for an operator to have a precise view of the apparatuses being controlled by the control board.

There is therefore a need for an apparatus and method of simply and efficiently operating multiple outfeed sectors manually thus reducing the complexity of traditional mill consoles.

### SUMMARY OF THE INVENTION

The shortcomings of the prior art are generally mitigated by a computer-implemented method to remotely operate one or more apparatuses which may comprise selecting a group of the apparatuses, dynamically and operatively associating a control to each of the apparatuses of the group of apparatuses and remotely controlling each of the associated apparatus using the control associated to the said associated apparatus.

In one aspect of the invention, the selection of the group of apparatuses may trigger the association of the controls to each of the apparatuses of the group of apparatuses. Moreover, the method may comprise displaying at least one video feed of the group of apparatuses with the selection of a group of apparatuses comprising selecting the video feed. A graphical overlay may further be added to the selected video feed with the graphical overlay showing boundaries of the group of apparatuses, comprising identification of the control associated to one of the apparatuses of the group and/or comprising a visual identification of each of the apparatuses displayed in the video feed. The visual identification of each of the apparatuses displayed in the video feed may further match a visual identification of the associated control.

In another aspect of the invention, the remote control of each of the associated apparatus may further comprise the control communicating with the associated apparatus through a data network.

In yet another aspect of the invention, the method may further comprise automatically selecting a group of apparatuses having an emergency and automatically associating the controls to each of the apparatuses of the selected group of apparatuses in response to an emergency from the group of apparatuses and automatically displaying at least one video feed of the group of apparatuses being the origin of the emergency

A system to remotely control a plurality of apparatuses is also provided. The system may comprise a user interface configured to select a group of apparatuses from the plurality of apparatuses and execute actions to control an apparatus as well as a controller in communication with the user interface, the controller being configured to dynamically and operatively connect the user interface to one of the apparatuses of a group of apparatuses, the connection allowing the user interface to operatively control the apparatus.

In one aspect of the invention, the system may comprise at least one sensor configured to capture a video feed of the group of apparatuses, the sensor being in communication with the controller. The controller may further be configured to add one or more graphical overlays to the captured video feed with the user interface further comprising a display configured to display the video feed with added graphical overlays. The user interface may comprise a plurality of displays, each display displaying a video feed of a group of apparatuses.

In another aspect of the invention, the user interface may comprise a plurality of controls, each of the controls being associable to one of the apparatuses of the selected group. The controls may be joysticks and the user interface may further comprise a display configured to display the association between the apparatuses and the controls.

In yet another aspect of the invention, the controller may a human-machine interface and the apparatuses may be adapted to convey bundles of wood.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is an illustration of a prior art control board for operating apparatuses from a distance.

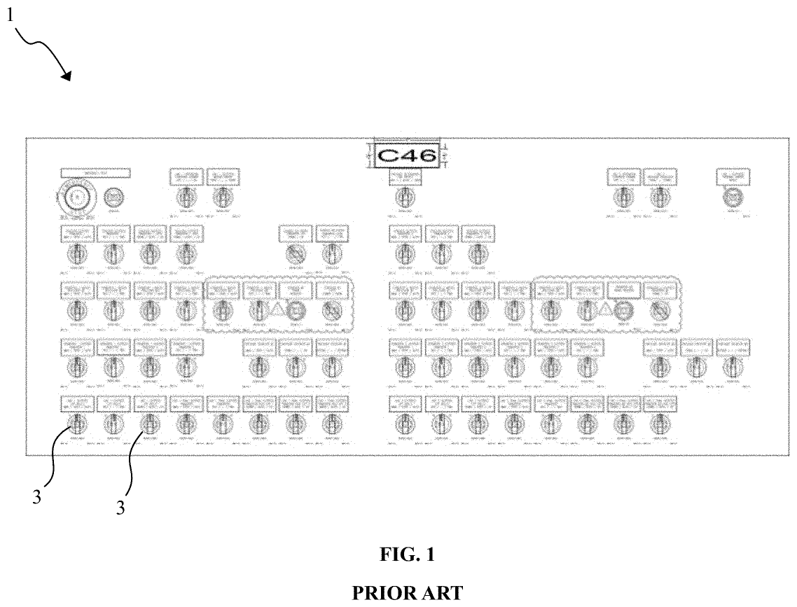

FIG. 2 is an illustration of an exemplary system to remotely control a plurality of apparatuses in accordance with the principles of the present invention.

FIG. 3 is a perspective view of an exemplary console of an embodiment of a system to remotely control a plurality of apparatuses in accordance with the principles of the present invention.

FIG. 4 is a top view of an exemplary user interface and controller of an embodiment of a system to remotely control a plurality of apparatuses in accordance with the principles of the present invention.

FIG. 5A is an exemplary screenshot of a video feed of a group of apparatuses captured by a sensor of an embodiment of a system to remotely control a plurality of apparatuses in accordance with the principles of the present invention.

5B is an exemplary screenshot of a video feed of a second group of apparatuses captured by the system of FIG. 5A.

5C is an exemplary screenshot of a video feed of a third group of apparatuses captured by the system of FIG. 5A.

5D is an exemplary screenshot of a video feed of a fourth group of apparatuses captured by the system of FIG. 5A.

FIG. 6 is a top plan view of an exemplary lumber mill controlled by an embodiment of a system to remotely control a plurality of apparatuses in accordance with the principles of the present invention.

FIG. 7 is a side plan view of an exemplary identifier used in an embodiment of a system to remotely control a plurality of apparatuses in accordance with the principles of the present invention.

FIG. 8 is a block diagram of a method to remotely operate one or more apparatuses according to the principles of the present invention.

### DETAILED DESCRIPTION OF THE PREFERRED EMBODIMENT

A novel system and method to manually control bundle outfeed apparatuses will be described hereinafter. Although the invention is described in terms of specific illustrative embodiments, it is to be understood that the embodiments described herein are by way of example only and that the scope of the invention is not intended to be limited thereby.

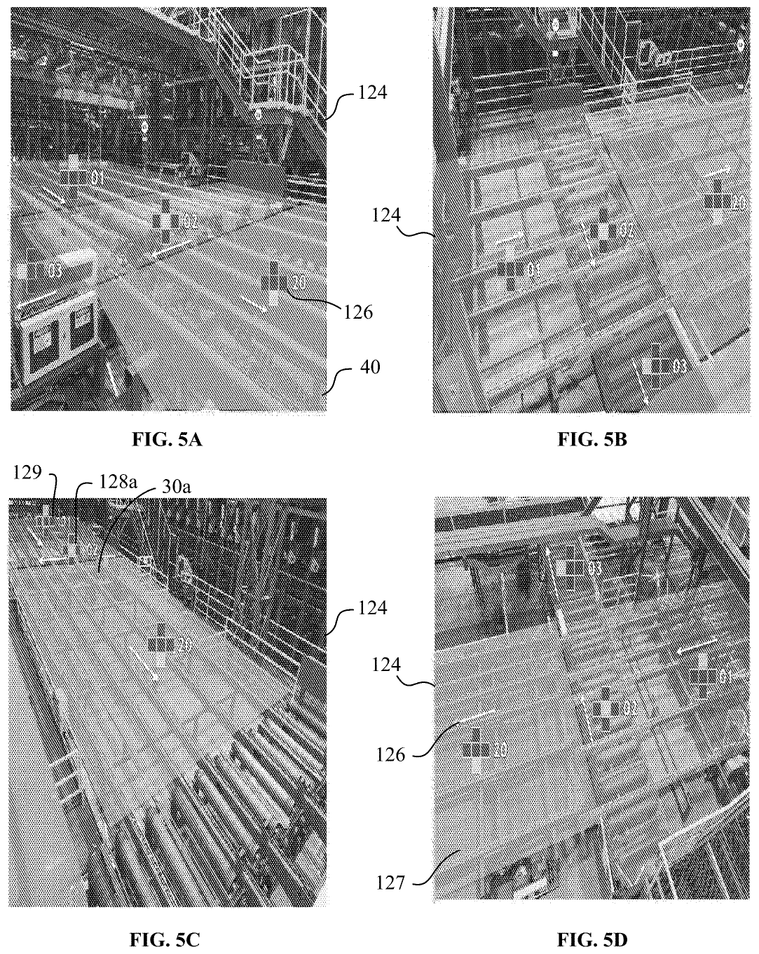

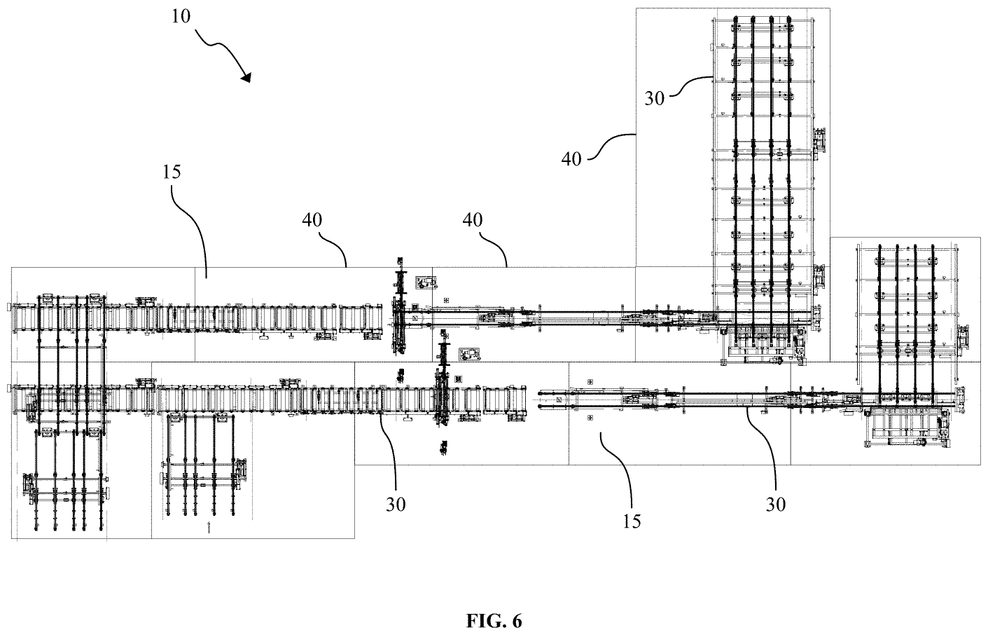

Referring to FIGS. 5 and 6, an embodiment of a sawmill or lumber mill 10 is illustrated. The lumber mill 10 may comprise one or more production lines 15 each comprising one or more apparatus 30. The apparatus 30 may be adapted to process, convey or generally perform any other action on a piece of lumber or wood passing therethrough. For example, the apparatus 30 may comprise, but are not limited to, conveyors, belts, carousels and transporters. In certain embodiments, the apparatus 30 may be adapted to convey bundles of wood within the lumber mill 10.

Broadly speaking, the apparatus management system 100 is adapted to operate the one or more apparatus 30 of the one or more production lines 15 in the lumber mill 10 and to manually intervene in operations when necessary, by providing an operator an overview of the one or more production lines 15 while selectively and easily associating controls to a desired apparatus 30. In typical embodiments, the operations are automatic but the system 100 overrides the automatic operation when needed or in case of a problem. In particular, the apparatus management system 100 may be configured to dynamically associate the controls of an input or user interface 140 to control or operate various apparatus 30. To that end, the apparatus management system 100 may comprise a controller unit (not shown), such as a CPU or a computer or any computerized device.

Understandably, the present invention is not limited to production lines 15 of lumber mills 10 but may be used in other industries requiring conveying articles or bundles of articles from one production station to another.

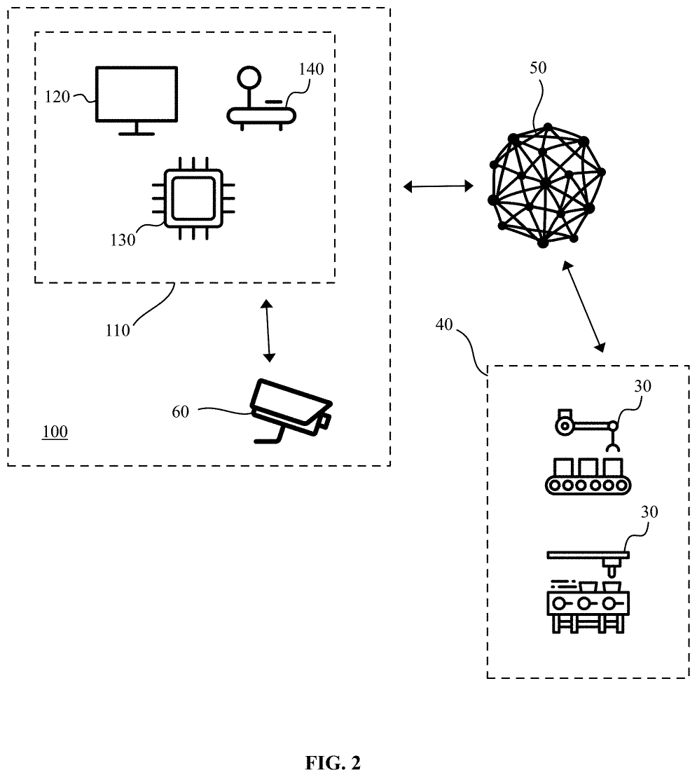

Referring now to FIG. 2, an embodiment of the apparatus management system 100 for controlling the operation of one or more apparatus 30 of the one or more production lines 15 is illustrated. The apparatus management system 100 typically comprises a console 110 in operative communication with the apparatuses 30. In one embodiment, the console 110 comprises a display 120, a mapping controller 130 and an input interface 140. The console 110 may further be connected to the apparatuses 30 through a network 50. The system further comprises an image sensor 60, such as a camera or radar.

Broadly, the apparatus management system 100 provides an operator the ability to select one or more apparatus 30 using the mapping controller 130. The mapping controller 130 is configured to store the apparatuses 30 of a zone 40 of the production line 15 in memory. The mapping controller 130 is further configured to associate or match in memory each apparatus 30 of the zone 40 to a control 142 of the input interface 140. Upon associating the apparatus 30 to the control 142, the control 142 will be operatively connected to the apparatus 30. Therefore, a user manipulating a control 142 shall manually operate the associated apparatus 30.

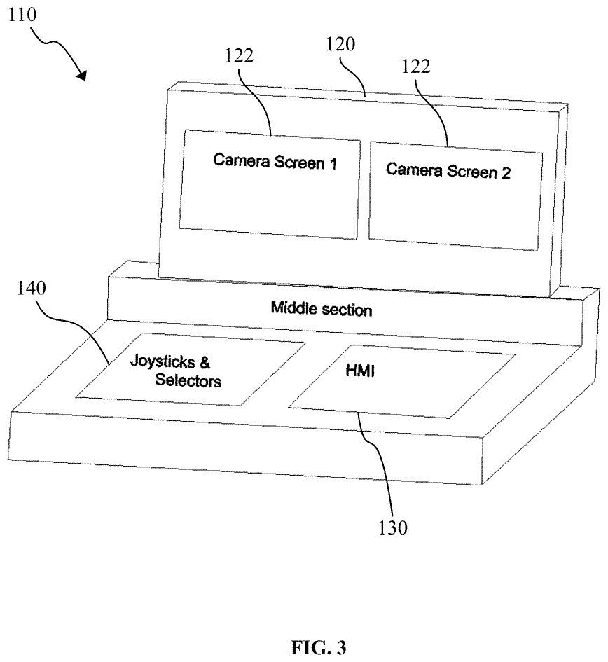

Referring now to FIG. 3, an embodiment of the console 110 is illustrated. In such embodiment, the console comprises the display 120. The display 120 generally comprises one or more monitors 122, such as but not limited to a LED monitor. The display 120 is in communication with the image sensor 60, the display 120 showing the captured image or video of the sensor in the display 120, such as one monitor 122 displaying each selected camera.

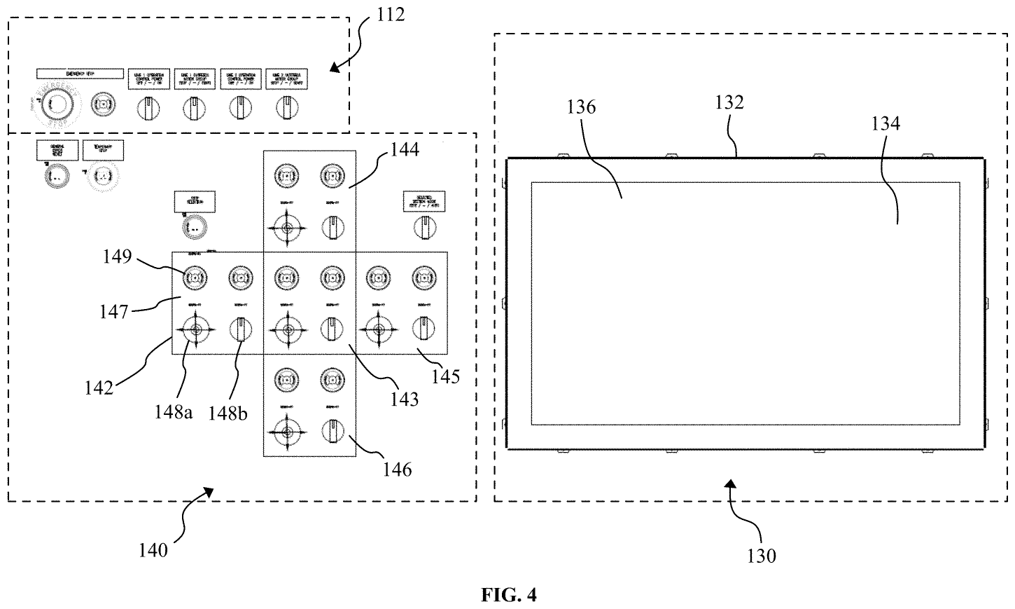

Referring now to FIG. 4, an embodiment of the mapping controller 130 and the input interface 140 is illustrated. In certain embodiments, the input interface 140 comprises one or more input means 142 suitable for the operation of the apparatus 30. The input means 142 may be embodied as joysticks, switches, knobs, rolling balls, keys, touchscreens or any other suitable input means for a user to interface with a system, apparatus or machine. In the illustrated embodiment, the input interface 140 comprises a plurality of controls 142 comprising joysticks 148a and switches 148b. Understandably, the controls 142 may be adapted to conform to the operational requirements of the apparatus 30. For example, the joysticks 148a and switches 148b may be adapted to operate conveyors or other machinery within the lumber mill 10 for the displacement of bundles of wood when associated to the apparatuses 30 by the mapping controller 130.

In embodiments comprising a plurality of controls 142, each control 142 may be mapped to an apparatus 30. For example, in the embodiment illustrated in FIG. 4, the input interface 140 comprises five controls each associated to an apparatus 30 of a zone 40. In particular, the five controls 142 are disposed in a cross pattern with a central control 143 adjoined by a top control 144, a right control 145, a bottom control 146 a left control 147. Understandably, the controlling interface 140 may comprise any other suitable or desirable number of controls 142 arranged in any desirable arrangement and with each control 142 comprising any desirable number of joysticks, switches or buttons adapted to control an apparatus.

The controls 142 may comprise unique visual identifiers or colors such as to be easily visibly discernible from one another to an operator. The visual identifiers may further comprise a colour overlay, symbols, lighting or any other suitable visual identification means.

In certain embodiments, the apparatus management system 100 may be adapted to provide control or operation of one or more zones 40 of the lumber mill 10. Each zone 40 may encompass an aspect or characteristic of an apparatus 30, one or more apparatus 30 or one or more production lines 15. Preferably, the zones 40 are assigned to encompass elements of the lumber mill 10 which operate in unison to perform a specific task. To that end, the input interface 140 may control one or more zones 40 thereby providing an operator a more intuitive control of a single or multiple apparatus 30 in unison for performing any desired process. In other embodiments, each of the controls 142 may be associated to more than one apparatus 30 of a zone 40.

The apparatus management system 100 generally allows the control of a plurality of zones or groupings 40. As such, a user selects a zone 40, typically by selecting one of the zones 40 shown on the display 120. The system 100 maps the control or operation of each of the apparatus 30 comprised in zone 40 to a control 142. As a result, the operator may simultaneously control or operate the apparatuses 30 being part of the selected zone 40 using the plurality of mapped controls 142. Understandably, some zones 40 may comprise a plurality of apparatuses 30 being lower than the number of available controls 142, as such, some of the controls 142 may remain unmapped and thus inactive in the context of the selected zone.

In certain embodiments, the mapping controller 130 is in operative communication with the apparatuses 30 of the production line 15. The mapping controller 130 is thus adapted to send commands and/or requests to the apparatuses, such as a command to activate movement of the apparatus 30. The mapping controller 130 is further configured to store the apparatuses 30 forming a group of apparatuses 40. The mapping controller 130 is further in operative communication with the controls 142. As such, the mapping controller 130 is configured to receive signals from the controls 142 triggered by an input of an operator. The mapping controller 130 is configured to store the association between a control 142 and one or more apparatuses 30. Thus, upon receiving a signal from the control 142, the mapping controller 130 fetches the apparatus 30 associated to the control 142 and sends a command to the associated apparatus 30 as a function of the received input signal.

The mapping controller 130 is further in communication with the display 120 and the sensors 60. In such embodiment, each sensor 60 communicates to the mapping controller 130 a video feed of a group 40 of apparatuses 30, also referred as a zone. The mapping controller 130 transmits or communicates the one or more video feeds to the display 120 to be viewed by the operator. The mapping controller 130 is further configured to receive the selection of a group 40. In some embodiments, the selection may be performed using a touch screen displaying the groups 40 or through any other interface to select a group, such as a drop down, an input box, a button, etc. Upon receiving the selected group 40 of apparatuses 30, the mapping controller 130 fetches the information to communicate with the apparatuses 30 comprised in the selected group 40. The mapping controller 130 further performs an association of the controls 142 with the fetched apparatuses 30.

In some embodiments, the mapping controller 130 is embodied as a HMI. The mapping controller 130 may comprise a central processing unit (CPU), a memory unit, a storage unit, input/output ports and a data communication unit. The storage unit is typically configured to store the network addresses or communication information of the apparatuses 30 of the production line 15, the information required to communicate with the controls 142 and/or the information required to obtain or get the stream of the cameras 60. The input/output ports may comprise one or more video ports, data ports and/or any other know input/output ports. The data communication unit may be embodied as wired or wireless communication module, such as, ethernet, WIFI, mobile communication unit, etc.

In certain embodiments, when the user selects another zone 40, the system 100 is configured to map the apparatuses 30 of the newly selected zone 40 to each of the controls 142.

The mapping or association controller 130 typically comprises a selection interface 132. The selection interface 132 generally allows an operator to select and assign one or more zones 40 to the controls 142. The selection interface 132 may further comprise one or more selectors 134 configured to operate the mapping controller 130. The selectors 134 may comprise one or more joysticks, switches, knobs, rolling balls, keys, touchscreens, trackpads, or any other suitable input means. Referring to FIG. 3, the section interface 132 is embodied as the display 120 showing the different zones 40 and a further display or human machine interface (HMI) 136 showing the mapping of the controls 142 to each of the apparatus 30.

Referring now to FIGS. 3 and 4, the console 100 comprises the HMI 136. The HMI 136 may comprise any suitable combination of software and hardware to display and control the mapping of the apparatuses 30 of the zone 40 to the operator. The HMI 136 may further be configured for an operator to manually change the mappings or the change the settings relating to one or more controls 142. The HMI 136 may further allow an operator to configure set points or control algorithms and parameters in the controller. Finally, the HMI 136 may further display process status information, historical information, reports, and other information to the operators.

In certain embodiments, the display 120 may be configured to display a visualization or information regarding the production lines 15. As stated above, the display 120 may comprise one or more displays 122 adapted to visually present information regarding different zones 40 or apparatuses 30 of the production lines 15. The displays 122 may be embodied as a CRT monitor, a LCD monitor, a segment display or any other display suitable for presenting visual information.

Referring to FIG. 3, the apparatus management system 100 comprises a display 120 comprising two monitors 122 adapted to present video images captured by the cameras 60 disposed within or around the lumber mill 10. Preferably, the cameras 60 are disposed within the lumber mill 10 such as to capture different zones 40 of the production lines 15 which may be controlled by the input interface 140.

Referring now to FIGS. 5A to 5D, exemplary video feeds 124 displayed by the display 120 are illustrated. In certain embodiments, each of the video feeds 124 may display a different view of the zones 40 or a different grouping. The views generally allow the operator to view the operations performed at different angles. Alternatively, one of the video feeds 124 may display a zone 40, while the other video feed displays a global view of the one or more production lines 15 or general data relating to the operations of the lumber mill 10. In a typical embodiment, each feed 124 comprises a plurality of apparatuses 30 which form a zone 40. Thus, a first exemplary zone 40 may comprise the apparatuses 30 named 01, 02 and 03 and a second exemplary zone 40 may comprise the apparatuses named 02, 04 and 05. Thus, the same apparatus 30 may be comprised in more than one zone 40.

In certain embodiments, the mapping controller 130 may be used in collaboration with the display 120 to assign the controls 142 to the zones 40. To that end, the display 120 may comprise a user interface allowing an operator to select one zone 40 and to assign them to one or more control 142. Upon selection, the mapping controller 130 is configured to map the apparatuses of the selected zone 40 to different controls 142.

The display 120 may be configured to display one or more graphical overlays 126 atop the video feeds 124. The graphical overlays 126 may illustrate the physical boundaries of the zones 40. The overlays 126 may further identify each of the one or more apparatus 30 forming part of the grouping 40 and the association of each of the apparatuses 30 to a specific control 142, the production directional flow or any other data or information regarding the operations performed within each of the apparatuses 30 or the grouping 40.

Referring to FIGS. 5A to 5D, exemplary graphical overlays 126 are illustrated on the video feeds 124. One graphical overlay 126 illustrates the physical boundaries 127 of each selected zone 40. Another overlay 126 is an association tag 128 in relation to an apparatus 30 of the zone 40. In such example, the association tag 128a overlaying apparatus 30a indicates that the central control 143 is currently associated and able to control or operate the apparatus 30a. In some embodiments, a color overlay 129 may be displayed over a specific apparatus 30. Thus, each apparatus 30 of the zone 40 is associated to a specific color. The control 142 may have the same color as the color overlaying an apparatus to ease human interventions. Understandably, the graphical overlay 126 may comprise any other suitable graphical design for identifying the controlled apparatus 30a or any other relevant data of the zone 40, such as arrows identifying the direction of the flow, name tags or warning/errors codes.

In certain embodiments, the mapping controller 130 may be configured to dynamically associate all the apparatuses 30 of the zone 40. For example, when an operator assigns a zone 40 via the selection interface 132, the mapping controller 130 automatically assigns the selected zone 40 to each of the controls 142. The mapping controller 130 may be configured to automatically determine the control 142 to associate to the apparatus 30 based on the physical position of the different apparatuses in the zone 40. As such, as shown in FIG. 5A, the apparatus 30 identified as 02 may be mapped to the central control 143 as the apparatus 30 identified as 02 is a central position of the zone 40. The mapping controller 130 next automatically maps other apparatuses to the remaining adjacent controls 142. In this manner, a single selection by the operator of a zone 40 may assign a plurality of controls 142 to a plurality of apparatuses 30.

The mapping controller 130 may dynamically map one or more controls 142 to one or more apparatuses 30 based on any suitable criterion such as, but not limited to, a predetermined association pattern, the relative placement between the adjacent apparatuses 30, the sequence of the production line 15, the relationship between adjacent apparatuses 30 or any other suitable criterion. For example, referring to FIG. 5D, the grouping 40 comprising apparatuses 01, 02, 03 and 20 may be dynamically mapped to the top control 144, the central control 143, the left control 147 and the bottom control 146, respectively. Accordingly, a single use of the mapping controller 130 may be used to assign a plurality of controls 142 to the apparatuses 30 of a zone 40.

The mapping controller 130 may further be adapted to automatically assign one or more controls 142 to one or more apparatuses 30 of a selected zone 40 when specific conditions are met. For example, a control 142 may be automatically assigned to an apparatus 30 in the event of an emergency or when the system 100 receives an error or warning code requiring immediate intervention thereby eliminating the use of the manual use of the mapping controller 130 by the operator. In such embodiment, the system 100 may automatically select the zone 40 from where an apparatus 30 requires manual intervention and map said zone 40 to a control 142.

The controls 142 may comprise a status indicator 149 adapted to inform an operator whether the control 142 has been associated to an apparatus 30 and is therefore operational. The status indicator 149 may accordingly offer a quick visual confirmation whether a control 142 is operational. The status indicator 149 may comprise an LED, an incandescent bulb, a switch or any other suitable visual indicator.

The mapping controller 130 may be in communication with a graphical module 136 configured to communicate the display feeds 124 to the display 120. The graphical module 136 may be configured to change the feeds to dynamically add the overlays 126. As such, the mapping controller 130 may configured to dynamically update the association tags 129 upon a new selection of a zone 40. The mapping controller 130 may additionally be in communication with the display 120 such as to automatically display the video feed 124 associated to a zone 40 having been selected.

In certain embodiments, the display 120 and the mapping controller 130 may form a unitary system (not shown).

In yet other embodiments, the mapping controller 130 and the display 120 may be a mobile computerized device adapted to receive the video feeds comprising a graphical user interface, such as a tablet or mobile device. In such embodiments, the computerized device may be further configured to display visual and interactive controls 142 which may be used to remotely operate the apparatuses 30 of selected zone 40.

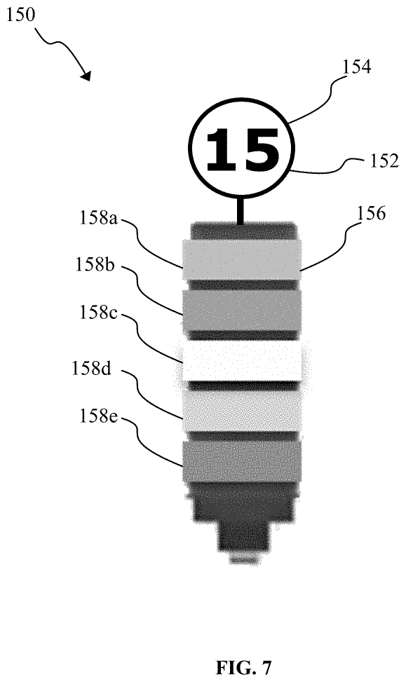

In certain embodiments, the mapping controller 130 may be operated without use of the display 120. Referring now to FIG. 7, the mapping controller 130 may comprise one or more identifiers 150 positioned within the lumber mill 10 to identify and distinguish the zones 40 of the lumber mill 10. The identifiers 150 may be preferably disposed within the lumber mill 10 near production lines 15, apparatus 30 or zones 40 such as to offer the operator a clear indication as to which machinery or function is associated to the identifiers 150. Alternatively, the identifiers 150 may comprise a visual indicator 152 to identify which machinery is associated to the identifiers 150 such as, for example, an arrow, a name tag, etc.

The identifiers 150 may comprise a unique tag 154 allowing the operator to identify the identifiers 150. For example, the unique tag 154 may comprise a name, a number, an alphanumeric code, a light, a symbol or any other suitable identification means. Accordingly, the mapping controller 130 may be adapted to receive an input indicating the identifier 150 to be associated to a control 142.

In certain embodiments, the identifiers 150 may further comprise an association indicator 156 adapted to visibly indicate the control 142 associated to said identifier 150. The association indicator 156 may comprise a display, a lighting system or any other suitable system for visually displaying information from a distance. Still referring to FIG. 7, the association indicator 156 comprises a lighting system defined by a plurality of visual indicators 158 for indicating the control 142 associated thereto. Each visual indicator 158 may be associated to a control 142 allowing an operator to identify which control 142 is associated to a specific apparatus 30 of a selected zone 40 without reliance on the display 120. For example, a first visual indicator 158a may be associated to the top control 144, a second visual indicator 158b may be associated to the right control 145, a third visual indicator 158c may be associated to the central control 143, a fourth visual indicator 158d may be associated to the bottom control 146, and a fifth visual indicator 158e may be associated to the left control 147. Understandably, the association indicator may comprise any other suitable form for visually relaying information.

In certain embodiments, the graphical module 136 may be adapted to present a graphical overlay 126 having a characteristic (such as a colour) similar to that of the association indicator 156 for the same apparatus 30. For example, an apparatus 30 viewed in a video feed 124 may comprise a graphical overlay 126 having the same colour as a lighting system of the association indicator 156 thereby allowing the operator to quickly relate a positioning within the video feed 124 to a position within the lumber mill 10.

The console 110 may additionally comprise one or more general controls 112 configured to control or regulate global functions of the lumber mill 10 or a production line 15. The general controls 112 may operate, for example, power to the entire lumber mill 10, a production line 15 or an apparatus 30, an emergency stop, a system reset or any other suitable system. Preferably, the general controls 112 always remain accessible to the operator without the possibility of reassigning them to a specific grouping 40. Referring to FIG. 3, the general controls 112 may be disposed adjacent to the mapping controller 130. Understandably, the general controls 112 may be disposed in any other suitable location on the apparatus management system 100.

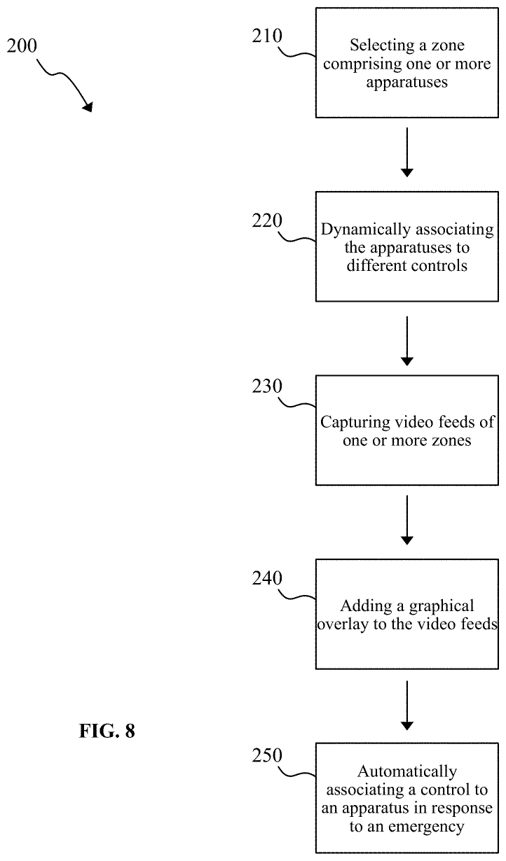

Referring now to FIG. 8, a method of operating apparatus 200 is presented. The method 200 comprises selecting a zone 40 comprising a one or more apparatuses 30, 210. The method further comprises dynamically associating each of the apparatuses 30 to different controls 220, the association allowing a control 142 to operatively control the mapped apparatus 30.

The method 200 may further comprise capturing image or video feeds of one or more zones 40, 230 and displaying the captured feeds 124 to the operator 240. The selection of the zone 40, 210 may further comprise selecting a displayed zone 40.

The method 200 may further comprise adding an overlay 232 to the video feeds 124. The displayed overlay 126 may comprise data relating to the apparatus 30, such as but not limited to the flow direction, the name tag, the identification number, control associated to the apparatus 30, etc.

The method 200 may further comprise automatically associating one of the inputs to one of the apparatus in response to an emergency 250.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A computer-implemented method to remotely operate one or more apparatuses, the method comprising:
selecting a group of the apparatuses;
dynamically and operatively associating a control to each of the apparatuses of the group of apparatuses;
remotely controlling each of the associated apparatus using the control associated to the said associated apparatus.

2. The computer-implemented method of claim 1, the selection of the group of apparatuses triggering the association of the controls to each of the apparatuses of the group of apparatuses.

3. The computer-implemented method of claim 1, the method comprising displaying at least one video feed of the group of apparatuses.

4. The computer-implemented method of claim 3, the selection of a group of apparatuses comprising selecting the video feed.

5. The computer-implemented method of claim 4 comprising adding a graphical overlay to the selected video feed.

6. The computer-implemented method of claim 5, the graphical overlay being boundaries of the group of apparatuses.

7. The computer-implemented method of claim 5, the graphical overlay comprising identification of the control associated to one of the apparatuses of the group.

8. The computer-implemented method of claim 5, the graphical overlay comprising a visual identification of each of the apparatuses displayed in the video feed.

9. The computer-implemented method of claim 8, the visual identification of each of the apparatuses displayed in the video feed matching a visual identification of the associated control.

10. The computer-implemented method of claim 1, the remote control of each of the associated apparatus further comprising the control communicating with the associated apparatus through a data network.

11. The computer-implemented method of operating apparatus of claim 1 further comprising automatically selecting a group of apparatuses having an emergency and automatically associating the controls to each of the apparatuses of the selected group of apparatuses in response to an emergency from the group of apparatuses.

12. The computer-implemented method of claim 11, the method further comprising automatically displaying at least one video feed of the group of apparatuses being the origin of the emergency

13. A system to remotely control a plurality of apparatuses, the system comprising:
a user interface configured to:
select a group of apparatuses from the plurality of apparatuses;
execute actions to control an apparatus;
a controller in communication with the user interface, the controller being configured to dynamically and operatively connect the user interface to one of the apparatuses of a group of apparatuses, the connection allowing the user interface to operatively control the apparatus.

14. The system of claim 13 further comprising at least one sensor configured to capture a video feed of the group of apparatuses, the sensor being in communication with the controller.

15. The system of claim 14, the controller being further configured to add one or more graphical overlays to the captured video feed.

16. The system of claim 15, the user interface further comprising a display configured to display the video feed with added graphical overlays.

17. The system of claim 16, the user interface comprising a plurality of displays, each display displaying a video feed of a group of apparatuses.

18. The system of claim 13, the user interface comprising a plurality of controls, each of the controls being associable to one of the apparatuses of the selected group.

19. The system of claim 18, the controls being joysticks.

20. The system of claim 18, the user interface further comprising a display configured to display the association between the apparatuses and the controls.

21. The system of claim 13, the controller being a human-machine interface.

22. The system of claim 13, the apparatuses being adapted to convey bundles of wood.
